(19) United States
(12) Patent Application Publication
(10) Pub. No.: US 2008/0028317 A1
(43) Pub. Date: Jan. 31, 2008

(54) METHOD AND COMPUTER PROGRAM PRODUCT FOR AUTOMATIC MANAGEMENT OF MOVABLE TIME IN CALENDARS

(75) Inventors: Vittorio Castelli, Croton on Hudson, NY (US); Guruduth S. Banavar, Pelham Manor, NY (US)

Correspondence Address: CANTOR COLBURN LLP-IBM YORKTOWN, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 11/460,130

(22) Filed: Jul. 26, 2006

(51) Int. Cl. G05B 19/418

(52) U.S. Cl. 715/744; 705/8; 715/963

(57) ABSTRACT

A computer implemented method for scheduling time of a user for at least one event, the method includes selecting, for each event, at least one of a time slot and a set of constraints for a time period, wherein the set of constraints are selected from a plurality of constraints; entering at least one of the time slot and the set of constraints into a calendar of the user; and scheduling the time for the user according to the available time indicated in the calendar and at least one of the time slot and the set of constraints.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

The invention generally relates to systems and methods for collaboratively managing calendars to effectively enable their use simultaneously as a collaborative tool and as personal time-management tools.

2. Description of the Related Art

All electronic calendars allow users to allocate time to activities (such as meetings) and to alert users to upcoming events (stated another way, that a switch from an activity to the next one is imminent: for example, a calendar can be set up to remind its user to go to a meeting, and the user can select when the calendar should provide the notification, say, 15 minutes before the event). Notifications can have “snooze” functions, just like alarm clocks. Calendars also provide easy way to manually manage individual events, typically by opening a dialog that allows the user to modify properties such as the title, the starting date and time, and the duration.

Using these functions, the user can turn an electronic calendar into a time-management tool, and the calendar can correspondingly regulate the user activities by providing appropriate notifications of events, such as phone conferences or meetings, and of the need to switch to a new individual activity. For example, the user could record in the calendar information regarding a meeting from 9 to 10, mark 2 hours to work on a customer account between 10 and 12, record a working lunch between 12 and 1, mark the time between 1 and 2:30 to write a memo, etc. Using a calendar in this fashion turns it into a powerful time-management tool that enhances their efficiency and productivity. That is, users can periodically plan the use of their time, mark the electronic calendar accordingly, and let the calendar regulate their activities by providing appropriate notifications.

Electronic calendars have also been proposed as personal time management tools for people with cognitive difficulties, such as mild and moderate Alzheimer disease. For people with diseases or disabilities, additional features have been proposed for calendars, such as the ability to deal with “floating” tasks: here the calendar can be programmed to remind the user to perform a certain activity, say take a medication, by a certain deadline, say, by the end of the morning; the calendar is used to monitor all the activities of the user, which can vary from day to day, so the actual notification of when to take the medication is generated by the calendar automatically at the first convenient opportunity within the desired time frame.

Calendar applications can also be used as collaborative tools. One of the most powerful way of using calendars as a collaborative tool is for the scheduling of meetings. Networked calendar applications, such as Lotus Notes Calendar, allow one user to check whether the people that need to participate to a meeting have other activities scheduled at the intended time of the meeting; a related feature is the ability of the calendar to find the closest time slot to a desired date and time where all the desired participants to a meeting do not have conflicting activities. These features substantially streamline processes that are traditionally complex and time-consuming, and that, at the same time, are becoming increasingly important because collaborating teams are increasingly geographically dispersed.

Unfortunately, existing calendar applications do not work simultaneously as collaborative tools and as time-management tools. For example, consider the user who plans a week of work and allocates appropriate time slots on the calendar to the desired activities. In this example, the time slots for the user are filled with time periods associated to the activity and become immediately unavailable for scheduling meetings, teleconferences, or phone calls. Another user who tries to schedule such a collaborative event will not be able to schedule it during any of the time slots marked by the first user on his calendar. As a consequence, people typically use different approaches to manage personal time and to collaboratively schedule events: for example some people use a paper agenda or a second calendar application for personal time management, and the networked calendar for collaborative scheduling.

These solutions have several drawbacks. First, the user has now the additional burden of managing two calendars. Second, paper agendas do not provide notifications. Additionally, networked calendars often are multi-platform, allowing the user to access them from their desktop, PDAs, and even cell-phones, while personal electronic calendars typically do not have this desired property. Further, and perhaps most significantly, the effectiveness of the calendar as collaborative tool is reduced and the calendar does not really perform the intended functions. The fact that a user has an available time slot does not mean that he or she has available time for a meeting or a phone conference. Typically, this information is available through the personal calendar, not through the collaborative tool.

What is needed is a method and a system for using a calendar both as a time management tool and as a collaborative tool.

### SUMMARY OF THE INVENTION

The shortcomings of the prior art are overcome and additional advantages are provided through the provision of a computer implemented method for scheduling time of a user for at least one event, the method including: selecting, for each event, at least one of a time slot and a set of constraints for a time period, wherein the set of constraints are selected from a plurality of constraints; entering at least one of the time slot and the set of constraints into a calendar of the user; and scheduling the time for the user according to the available time indicated in the calendar and at least one of the time slot and the set of constraints.

Also disclosed is a computer implemented method for scheduling time of a user for at least one event, the method including: a requester selecting, for each event, at least one of a time slot and a set of constraints for a time period, wherein the set of constraints are selected from a plurality of constraints; wherein the set of constraints includes at least one of a hard deadline, a preferred deadline, whether the time period for the event can be split in multiple sessions, a minimum length for each session, a preferred length for each session, whether the event depends on the completion of another event, preferences on the time of the day for aspects of the event and the importance of the event and at least one constraint within the plurality of constraints includes a default value; the requester entering at least one of the time slot and the set of constraints into a calendar of the user; and scheduling the time for the user according to the available time indicated in the calendar and at least one of the time slot and the set of constraints; wherein scheduling includes at least one of automatically, manually and selectively adjusting a schedule for the time period and includes determining if a schedule for the time period can be adjusted without violating the set of constraints, wherein if the time period can not be moved without violating the set of constraints, then assigning at least one time slot for the time period.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which a computer program product including machine readable instructions stored on machine readable media, includes instructions for scheduling time of users for at least one event by selecting, for each event, at least one of a time slot and a set of constraints for a time period, wherein the set of constraints are selected from a plurality of constraints; entering at least one of the time slot and the set of constraints into a calendar of each user; providing scheduling options to at least one of the user and a requester; scheduling the time for each user according to the available time indicated in the calendar and at least one of the time slot and the set of constraints; and notifying at least one of the requester and the user of scheduling limitations.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a computer system for implementing the teachings herein;

FIG. 2 illustrates one example of adding events to a calendar according to the teachings herein;

FIG. 3 illustrates one example for evaluating the calendar of a user; and

FIG. 4 illustrates one example for allocating time of the user.

The detailed description explains the preferred embodiments of the invention, together with advantages and features, by way of example with reference to the drawings.

### DETAILED DESCRIPTION OF THE INVENTION

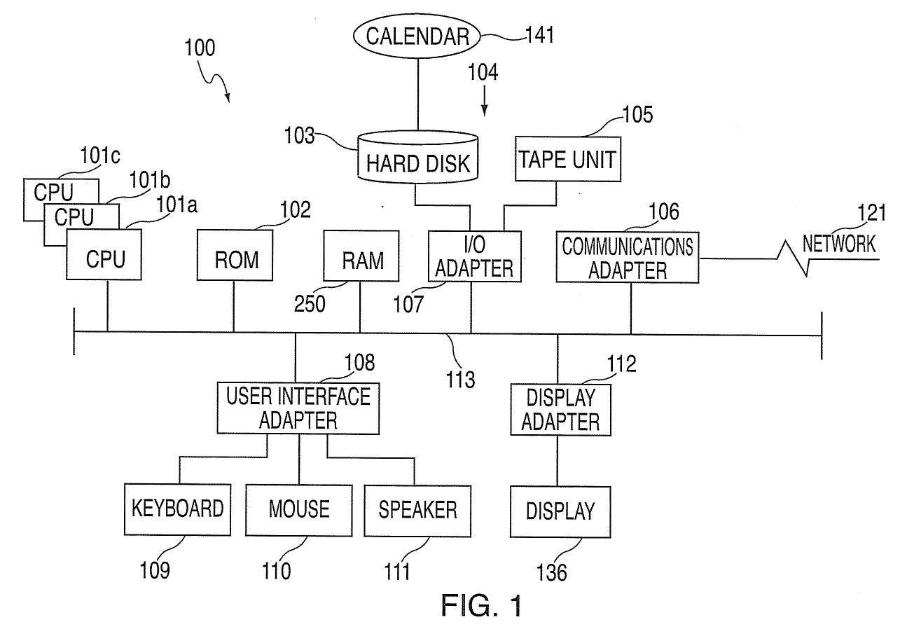

Referring now to FIG. 1, there are shown apparatus for implementation of the teachings herein. Referring now to FIG. 1, an embodiment of a computer system (100) for implementation of the present invention is depicted. In the exemplary embodiment, the system (100) has one or more central processing units (processors) (101a), (101b), (101c), etc. (collectively or generically referred to as processor(s) (101)). Processors (101) are coupled to system memory (250) and various other components via a system bus (113). Read only memory (ROM) (102) is coupled to the system bus (113) and may include a basic input/output system (BIOS), which controls certain basic functions of the system (100).

FIG. 1 further depicts an I/O adapter (107) and a network adapter (106) coupled to the system bus (113). I/O adapter (107) may be a small computer system interface (SCSI) adapter that communicates with a hard disk (103) and/or tape storage drive (105) or any other similar component. I/O adapter (107), hard disk (103), and tape storage device (105) are collectively referred to herein as mass storage (104). A network adapter (106) interconnects bus (113) with an outside network (121) enabling the system (100) to communicate with other such systems. Display monitor (136) is connected to system bus (113) by display adaptor (112), which may include a graphics adapter to improve the performance of graphics intensive applications and a video controller. In one embodiment, adapters (107), (106), and (112) may be connected to one or more I/O busses that are connected to system bus (113) via an intermediate bus bridge (not shown). Suitable I/O buses for connecting peripheral devices such as hard disk controllers, network adapters, and graphics adapters typically include common protocols, such as the Peripheral Components Interface (PCI) bus. Additional input/output devices are shown as connected to system bus (113) via user interface adapter (108) and display adapter (112). A keyboard (109), mouse (110), and speaker (111) are all interconnected to bus (113) via user interface adapter (108).

Thus, as configured in FIG. 1, the system (100) includes processing means in the form of processors (101), storage means including system memory (250) and mass storage (104), input means such as keyboard (109) and mouse (110), and output means including speaker (111) and display (136). In one embodiment, a portion of system memory (250) and mass storage (104) collectively store an operating system such as the AIX® operating system from IBM Corporation to coordinate the functions of the various components shown in FIG. 1.

With reference to FIG. 1, the system (100) provides various forms of machine readable media (such as the system memory (250), ROM (102), hard disk (103), etc, . . . ) for storing and providing machine readable instructions. The machine readable instructions provide for implementation of a calendar (141) according to the teachings herein. In this non-limiting example, the calendar (141) is stored upon the hard disk (103). It should be noted that as used herein, the term calendar (141) makes reference to specific calendars (as in defined periods of time identified in a data file) and also makes reference to machine readable instructions as software applications for generation of each calendar file. It is expected that one skilled in the art, particularly in light of the context of the teachings, is enable to make appropriate distinctions between calendar files, calendar applications and other forms of calendars as may be discussed herein. That is, the calendar (141) may include at least one of a calendar file and a calendar application.

In order to provide some context for the teachings herein, some terminology is now generally defined. The term “time slot” denotes a consecutive interval of time within a calendar application. For example, the period between 9 A.M. and 10 A.M. on a specific date is a time slot. It is important to note that the term is used broadly, and in particular does not imply a fixed length of time: for example, the periods between 9 and 10 A.M. and between 10 A.M. and 11:45 A.M. can be two time slots within the same calendar (141), despite their different duration. Typically, a time slot is defined by a user of the calendar (141).

The term “Time Period” denotes an interval of time allocated to an event or to a portion of an event or an activity. For example, if the user records a meeting between 9 A.M. and 10 A.M. on a specific date, the “time period” for the event correlates to a specific time slot in the user's calendar. In general, an event might be composed of a collection of time periods. For example, a meeting could go from 10 A.M. to 12 P.M. and from 1 P.M. to 3 P.M., with a break for lunch. In this case, the event consists of two distinct time periods. Another example provides for allocating the time period from 7:30 A.M. to 8:00 A.M. every working day of the year to the activity of planning the working day. Hence, the time slots from 7:30 A.M. to 8:00 A.M. become allocated to time periods associated with the day-planning activity.

Further, note that at least in some regards, the terms “event” and “task” are interchangeable herein. That is, while a user may attend an event and the user may perform a task, either one of the event and the task will consume the time of the user. At least in this regard, these terms may be considered synonymous.

The electronic calendar applications taught in the prior art are used for either one of personal time management and collaborative time management.

In a typical embodiment of a calendar application disclosed herein, the calendar (141) includes features that provide for use both as a personal time-management tool and as a collaborative tool.

As a basis for the teachings herein, consider the premise that most tasks that require personal time typically are to be performed within a specific time frame and require some estimated amount of time to be completed. As an example, the user might need to write a memo by the end of the week. The user is able to estimate, based on personal experience and knowledge of the task at hand, that writing the memo will require, about four hours. Additionally, the user might decide that the task need not be completed in a single session of four hours. Finally, based on preference and on working style, the user might decide that individual sessions to work on the memo should be at least one hour long. Setting constraints upon the task of writing the memo provide for the versatility of the calendar (141).

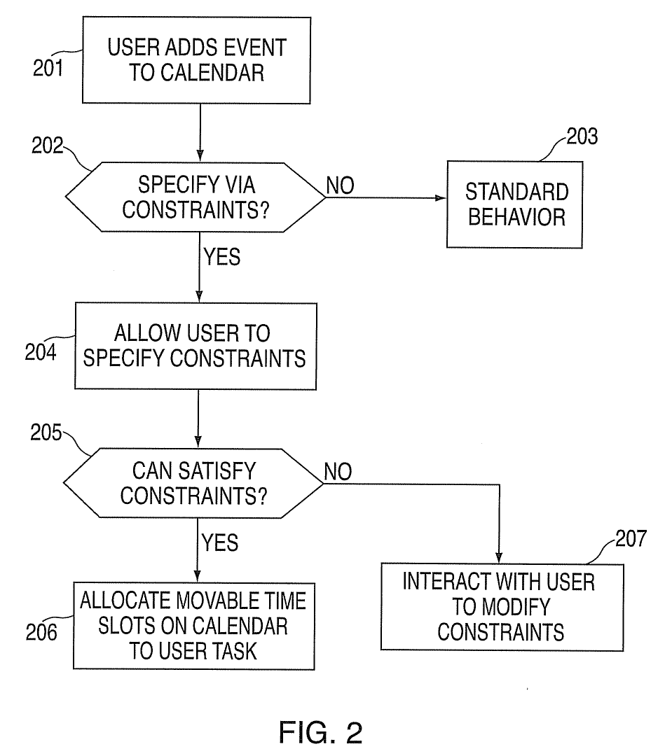

In a typical embodiment and as described with the help of FIG. 2, in Step (201) the user opens the calendar application, and activates a control that creates a new task (one of ordinary skill would appreciate that this control could be, for example, a button, a toolbar icon, an item in a menu, etc.). The calendar application allows the user to allocate time in two ways. As example, in Step (202), the user has an option of following a traditional (prior art) fashion and a method according to the teachings herein. Using the prior art technique, the user specifies a time slot in which the task needs to be preformed. If the user selects the prior art method, in Step (203) the calendar application behaves like the calendar application known in the art.

Alternatively, a technique for allocating time in accordance with the present teachings, includes specifying constraints for the task. If the user selects this second method, in Step (204) the calendar application responds with a dialog that allows the user to specify constraints on the task. Non-limiting examples of constraints include: a hard deadline or a preferred deadline; a period of time needed to perform the task; whether the task should be performed in one session or can be split in multiple sessions, and in this last case the granularity of the task (i.e., the minimum length of a session and the preferred length of a session); whether the task depends on the completion of another task; preferences on the time of the day for aspects of the task (e.g., a user might prefer to read literature in the morning and to perform activities that require writing documents in the afternoon); and the importance of the task. The list of constraints on the task or event is not exhaustive, and some of these as well as other constraints could be presented to the user in the spirit of the present invention.

Note that in typical embodiments, the user need not specify values for all the constraints in a list. In these embodiments, the calendar (141) includes capabilities for substituting default values for the unspecified constraints. In one embodiment, the default values are hard-coded into the calendar application. In another embodiment, the user can select the default values for the constraints using an appropriate “user preference” dialog. Typically, the user selected default values are written to and stored in a user configuration data file and maintained with the calendar (141).

When the user completes or terminates specifying the constraints on the task, in Step (205) the calendar application checks whether it is possible to satisfy the constraints by allocating time in unused time slots within the calendar file for the user. If the calendar application can satisfy the constraints, it allocates time slots in the user calendar for the task, in Step (206). Otherwise, it notifies the user that it cannot satisfy the task and prompts the user to modify the constraints, or guides the user in the constraint modification process in Step (207). One of ordinary skills in the art would appreciate how the process of checking whether the constraints can be satisfied can be performed using standard methods taught in the scheduling art.

Time periods that are manually allocated in the calendar (141) by the user either by specifying the time slots or by accepting an invitation to a collaborative event are considered as unmovable by the calendar application, while time periods that are allocated by the calendar application to satisfy a collection of constraints on a task specified by the user are called movable in the spirit of scheduling and time management. Movable and unmovable time periods are managed differently by the calendar application. Unmovable time periods are typically managed in the same way as standard calendar applications manage time periods allocated by the user. In the spirit of the present invention, the calendar application is allowed to reschedule movable time periods to different time slots provided that this it is possible to do so while at the same time satisfying the user constraints.

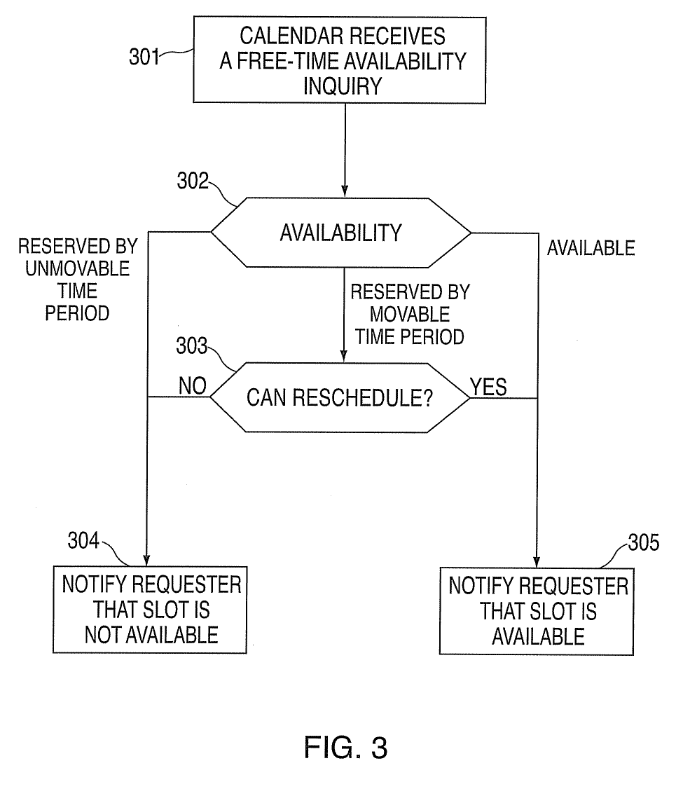

The calendar (141) includes various features useful for a collaborative tool. As an example of techniques for collaboration, consider aspects of collaboration depicted in FIG. 3. In Step (301) the calendar application receives an inquiry of availability of a specific time slot from the calendar application of another user, for example, when the another user wants to schedule a meeting or a phone conversation. In Step (302) the calendar application checks the status of the requested time slot. There are generally three scenarios for this scheduling request.

First, if the requested time slot is allocated to one or more movable time periods, in Step (303) the calendar application checks whether it is possible to free the requested time slot by moving the occupying movable time periods, while satisfying the user constraints. As one of ordinary skills in the art would appreciate, this operation can be performed using scheduling algorithms taught in the art. If it is possible to free the time slot, in Step (305) the calendar application notifies the requesting calendar application that the time slot is free. If it is not possible to free the time slot, in Step (304) the calendar application notifies the requester that the time slot is not available.

In some embodiments, the user may require the calendar (141) to obtain permission prior to adjusting movable time periods. In other embodiments, the user may permit the calendar (141) to automatically adjust movable time periods from one time slot to another. In some farther embodiments, the user may selectively chose other users for whom automatic time adjustments are made, while requiring permission prior to granting other users adjustments to movable time periods.

In a second scenario, if the requested time slot is occupied by an unmovable time period, in Step (204) the calendar application notifies the requester that the requested time slot is not available.

Third of all, if the requested time slot is not occupied, in Step (305) the calendar application notifies the requesting calendar application that the time slot is free.

Note that in typical embodiments, the requester is another user. That is, it is known in the art that networked systems (100) permit users to query and review the schedule of other users. In this regard, a requester may be regarded as another user from a plurality of users.

One of ordinary skills in the art would appreciate how the behavior described in FIG. 3 enables the calendar (141) to be used both as a personal time management system and as a collaborative tool. Unlike prior art calendar applications, in which the user effectively prevents other calendar applications from identifying time slots that are actually available for scheduling collaborative events, the behavior described in relation to FIG. 3 allows the calendar (141) of the present invention to treat a time slot occupied by a movable time period as if they were unoccupied if it is possible to reschedule the time period to future slots. With this feature, a user can schedule a collaborative event and identify as available time slots that are currently occupied by movable time periods on the calendars of the desired participants to the event, provided that the movable time periods can be rescheduled while satisfying the specified constraints. For example, if the calendar application allows a user to visually inspect the time slot availability on the calendars of the desired participants to the event, the method described in FIG. 3 would graphically make appear as available all the time slots occupied by movable times that can be rescheduled.

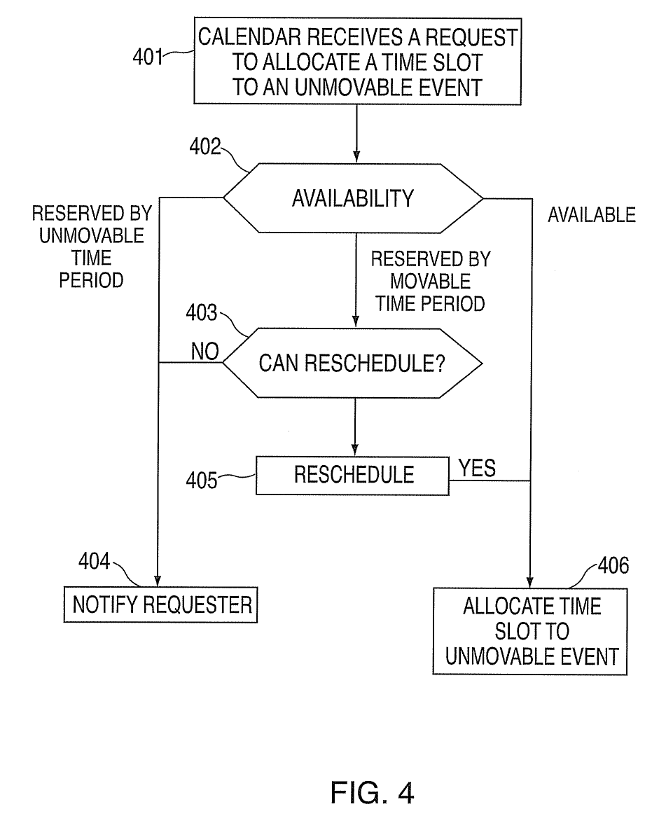

In further detail, FIG. 4 describes behavior of the calendar (141) when a user allocates an unmovable time period, either directly or by accepting an invitation to a collaborative event. In Step (401) the calendar application receives instructions to allocate a specified time slot to an unmovable event (this feature can also be applied to the simultaneous allocation of multiple time slots, for example, to the case of repeated events, such as weekly meetings). In Step (402) the calendar (141) checks the status of the requested time slot. There are generally three scenarios for this scheduling request.

First, if the requested time slot is allocated to one or more movable time periods, in Step (403) the calendar application checks whether it is possible to free the requested time slot by moving the occupying movable time periods, while satisfying the user constraints. As one of ordinary skills in the art would appreciate, this operation can be performed using scheduling algorithms taught in the art. If it is possible to free the time slot, in Step (405) the calendar application reschedules the movable time period that currently occupies the desired time slot, thus freeing the time slot, and then, in Step (406), it allocates the now free time slot to the unmovable event. If it is not possible to free the time slot, in Step (404) the calendar application notifies the requester of the existence of a conflict. What happens after Step (404) depends on the designer's intended behavior for the calendar (141). Typically, the calendar (141) permits users to schedule multiple events during the same time slot.

In a second scenario, if the requested time slot is occupied by an unmovable time period, in Step (304) the calendar application notifies the requester of the existence of a conflict.

Third of all, if the requested time slot is not occupied, in Step (406) the calendar (141) allocates the time slot to the unmovable time interval.

One of ordinary skills in the art of scheduling would appreciate that rescheduling a movable time periods to free a time slot could result in rescheduling multiple movable time periods. For example, consider the case in which the time slot from 2 P.M. to 3 P.M. is allocated to a task that needs to be performed by the end of the day (say, 5 P.M.), while the time slot from 3 P.M. to 5 P.M. is associated with a task that need to be performed within a ten day (10 day) time frame. Assume that both time periods are movable. Then the time slot between 2 P.M. and 3 P.M. could be freed if the time period associated to the 3 P.M. to 5 P.M. time slot could be rescheduled to a future date: then the time period associated with the 2 P.M. to 3 P.M. time slot could be moved to, say the 3 P.M. to 4 P.M. time slot.

Whenever a user adds an event to the calendar (both directly or by specifying constraints), the calendar application re-evaluates all the movable time periods, and identifies movable time periods that can no longer be rescheduled without violating the constraints. In typical embodiments, such time periods are then turned into unmovable time periods. Similarly, whenever the user cancels a scheduled event, in this embodiment, the calendar application identifies time periods specified via constraints that were previously turned into unmovable time periods and that can now be rescheduled while still satisfying the constraints, and turns them again into movable time periods.

Note that as used herein, the terms “adjustable” and “movable” are generally synonymous. That is, time periods that may be moved may also be adjusted equally as well.

From the viewpoint of the user, it is important to distinguish between movable and unmovable time periods. In a preferred embodiment, the calendar application uses visual clues, such as color or font type, to allow the user to quickly distinguish between movable and unmovable time periods.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A computer implemented method for scheduling time of a user for at least one event, the method comprising:
selecting, for each event, at least one of a time slot and a set of constraints for a time period, wherein the set of constraints are selected from a plurality of constraints;
entering at least one of the time slot and the set of constraints into a calendar of the user; and
scheduling the time for the user according to the available time indicated in the calendar and at least one of the time slot and the set of constraints.

2. The computer implemented method of claim 1, wherein at least one of the selecting and the entering are performed by another user.

3. The computer implemented method of claim 1, wherein the set of constraints comprises at least one of a hard deadline, a preferred deadline, whether the time period for the event can be split in multiple sessions, a minimum length for each session, a preferred length for each session, whether the event depends on the completion of another event, preferences on the time of the day for aspects of the event and the importance of the event.

4. The computer implemented method of claim 1, wherein scheduling comprises at least one of automatically, manually and selectively adjusting a schedule for the time period.

5. The computer implemented method of claim 1, wherein scheduling comprises determining if a schedule for the time period can be moved without violating the set of constraints.

6. The computer implemented method of claim 5, wherein if the time period can not be moved without violating the set of constraints, then assigning at least one time slot for the time period.

7. The computer implemented method of claim 1, wherein at least one constraint within the plurality of constraints comprises a default value.

8. The computer implemented method of claim 7, wherein the default value comprises a default value that is at least one of hard-coded into the calendar and pre-selected by the user.

9. The computer implemented method of claim 1, wherein the time slot represents one of an unmovable event and an unmovable task.

10. The computer implemented method of claim 1, wherein the time period represents one of a movable event and a movable task.

11. A computer program product comprising machine readable instructions stored on machine readable media, the instructions for scheduling time of users for at least one event and comprising:
selecting, for each event, at least one of a time slot and a set of constraints for a time period, wherein the set of constraints are selected from a plurality of constraints;
entering at least one of the time slot and the set of constraints into a calendar of each user; and
scheduling the time for each user according to the available time indicated in the calendar and at least one of the time slot and the set of constraints.

12. The computer program product as in claim 11, further comprising using a computer network for at least one of the selecting, entering and scheduling.

13. The computer program product as in claim 11, wherein at least one constraint from the plurality of constraints comprises a default value.

14. The computer program product as in claim 11, further comprising instructions for notifying a requester of scheduling limitations regarding the user.

15. The computer program product as in claim 11, further comprising instructions for providing scheduling options to at least one of the user and a requester prior to scheduling the time.

16. The computer program product as in claim 11, further comprising instructions for visually distinguishing the time slot from the time period.

17. The computer program product as in claim 16, wherein instructions for visually distinguishing comprises instructions for providing at least one of a different font and a different color.

18. A computer implemented method for scheduling time of a user for at least one event, the method comprising:
a requester selecting, for each event, at least one of a time slot and a set of constraints for a time period, wherein the set of constraints are selected from a plurality of constraints; wherein the set of constraints comprises at least one of a hard deadline, a preferred deadline, whether the time period for the event can be split in multiple sessions, a minimum length for each session, a preferred length for each session, whether the event depends on the completion of another event, preferences on the time of the day for aspects of the event and the importance of the event and at least one constraint within the plurality of constraints comprises a default value;
the requester entering at least one of the time slot and the set of constraints into a calendar of the user; and
scheduling the time for the user according to the available time indicated in the calendar and at least one of the time slot and the set of constraints; wherein scheduling comprises at least one of automatically, manually and selectively adjusting a schedule for the time period and comprises determining if a schedule for the time period can be adjusted without violating the set of constraints, wherein if the time period can not be moved without violating the set of constraints, then assigning at least one time slot for the time period.
